(19) United States
(12) Patent Application Publication
(10) Pub. No.: US 2022/0147719 A1
(43) Pub. Date: May 12, 2022

(54) DIALOGUE MANAGEMENT

(71) Applicant: Kabushiki Kaisha Toshiba, Tokyo (JP)

(72) Inventors: Svetlana STOYANCHEV, Cambridge (GB); Simon KEIZER, Cambridge (GB); Rama Sanand DODDIPATLA, Cambridge (GB)

(73) Assignee: Kabushiki Kaisha Toshiba, Tokyo (JP)

(21) Appl. No.: 17/187,462

(22) Filed: Feb. 26, 2021

(30) Foreign Application Priority Data
Nov. 9, 2020 (GB) 2017663.2

(51) Int. Cl. G06F 40/35; G06N 20/00; G06N 5/04

(52) U.S. Cl. CPC G06F 40/35; G06N 5/04; G06N 20/00

(57) ABSTRACT

A dialogue system comprising:
a user input
a processor; and
a memory
wherein the processor is adapted to update a dialogue state in response to a natural language input from a user, the dialogue state being stored in the memory,
the dialogue state comprising data structure that the stores the information exchanged between the user and the dialogue system,
the processor being configured to update said dialogue state by comparing said natural language input from the user with a plurality of possible actions, said actions indicating possible requests of the user, and update the state using information from an action that matches with the natural language input,
the processor being configured to generate a response to the natural language input using the updated state.

### CROSS REFERENCE TO RELATED APPLICATION

This application claims the benefit of United Kingdom Application number 2017663.2 filed on Nov. 9, 2020, which is hereby incorporated by reference.

### FIELD

Embodiments described herein relate to dialogue management.

### BACKGROUND

Dialogue systems, for example, task-oriented dialogue systems are natural language interfaces for tasks, such as information search, customer support, e-commerce, physical environment control, and human-robot interaction. Natural language is a universal communication interface that does not require users to learn a set of task-specific commands. A spoken interface allows the user to communicate by speaking, and a chat interface by typing. Correct interpretation of user input can be challenging for automatic dialogue systems which lack the grammatical and common sense knowledge that allows people to effortlessly interpret a wide variety of natural input.

### BRIEF DESCRIPTION OF FIGURES

Embodiments will now be described with reference to the following figures:

FIGS. 1A and 1B are schematics of a mobile using a dialogue system in accordance with an embodiment;

FIG. 2A is a schematic of a system in accordance with an embodiment, and FIG. 2B is a schematic of the applications shown in FIG. 2B;

FIG. 3 is a flow chart showing a method in accordance with an embodiment;

FIG. 4 is a schematic of an example dialogue state; and

FIG. 5 is a schematic of a system in accordance with an embodiment.

### DETAILED DESCRIPTION

In one embodiment, a module for updating a dialogue state for use in a dialogue system is provided, the dialogue system being for conducting a dialogue with a user, the module comprising:
a user input
a processor; and
a memory
wherein the processor is adapted to update a dialogue state in response to a natural language input from a user, the dialogue state being stored in the memory,
the dialogue state comprising a data structure that the stores the information exchanged between the user and the dialogue system, and
the processor being configured to update said dialogue state by comparing said natural language input from the user with a plurality of possible actions, said actions indicating possible requests of the user, and update the state using information from an action that matches with the natural language input.

In a state based dialogue system, a dialogue state is used to exchange information between the user and the system as the dialogue progresses. A challenge with state based dialogue systems is to update the state as more information is received from the user. When the user first makes an utterance to a dialogue system the dialogue state is generally empty and a dialogue starts. The system will then respond and the user will respond providing further information for the dialogue state to be updated. The system and the user then take turns providing utterances.

The disclosed module provides an improvement to computer functionality by allowing computer performance of a function not previously performed by a computer running a dialogue system that uses statistical model that takes text input of a user utterance as input. Specifically, the disclosed system provides for a dialogue system that can output a suitable response when a user refers back to information provided in an earlier turn of the dialogue. It provides this improvement by a 3 stage approach wherein, in an embodiment, the system:

1) infers the candidate actions from the dialogue state;

2) computes a relevance score ∈[0, 1] for each candidate action; and

3) updates the state with the most likely actions.

The above systems allows extended functionality without having to implement a domain-specific natural language understanding component. Further, there is no need to design annotation scheme and annotate intents and entities.

In an embodiment, the dialogue state comprises a data structure that comprises items that have been mentioned during the dialogue. In some embodiments, the dialogue state will store information by providing slots, in others a decision tree data structure will be provided. In other embodiments, some free text portions of the structure might be provided.

In an embodiment the plurality of possible actions includes actions regarding a plurality of items that have been mentioned during the dialogue. In some embodiments all items that have been mentioned in the dialogue can be included in possible actions. This allows the most recent utterance by the user to be compared with previous items referred to in the dialogue. In other embodiments, possible actions may be based on the last few turns and not the whole dialogue.

The plurality of possible actions are inferred from the state and the domain definition. Domain definition is a description of the data structure. For example, in the restaurant search domain, the domain definition includes a set of the informable/requestable slots. In a catalogue ordering domain it would be the item types and their attributes (colour, size, etc.). In a food ordering, it would be a structure representing the menu of the restaurant.

The domain definition can also contain domain-specific rules. For example, in a hotel reservation system, a user can to specify the arrival and departure dates OR date arrival and duration of stay. The domain definition (along with the current dialogue state) are used to generate a list of candidate actions.

The dialogue system can be adapted for many uses. One possible use is information retrieval. However, other uses are possible, for example information collection, trouble shooting, customer support, e-commerce, physical environment control, and human-robot interaction. The dialogue state comprises information exchanged between the user and the system. When the dialogue system is configured for information retrieval and said dialogue state comprises a user goal and history, said user goal indicating information that the user requires, said history defining items that have been previously retrieved in response to a user goal. The user goal may be the type of food desired by the user, the physical area of interest etc.

In a further embodiment, the processor is configured to compare the natural language input from the user with a plurality of possible actions, by using a binary classifier to indicate actions that are a match and those which are not. The binary classifier may be configured to output a score and said score is compare with a threshold to determine if an action is a match.

In one embodiment, the processor is configured to compare the natural language input from the user with a plurality of possible actions, by generating a plurality of model inputs for each action, each model input comprising the natural language input from the user and an action, the processing being further configured to input the model input to a binary classifier implemented as a trained machine learning model to output said score.

The trained machine learning model may be a transformer model. Transformer models use a self-attention mechanism by which the dependencies captured regardless of their distance. Transformer models may employ an encoder-decoder framework The trained machine learning model may be a bi-directional trained machine learning model such as BERT.

In an embodiment, the model inputs further comprise a previous response from the dialogue system. For example, the last system utterance may be used or a representation of the previous system utterance such as a lexical dialogue act corresponding to the system utterance.

In an embodiment, the actions may be selected from candidate actions and state update actions wherein candidate actions indicate a question asked by the user of a previous response from the system and state update actions indicate a request from the user not linked to a previous response from the system. The state update may represent a “goal change”.

The module inputs for actions may comprise: a representation of the previous response of the system; the user input; an item description of the items in the dialogue state history; and a proposed question relating to the item referred to in the item description. The module inputs for state update actions comprise: a representation of the previous response of the system; the user input; and a proposed question relating to a possible user query.

The above module may form part of a dialogue system. Therefore, in a further embodiment, a dialogue system comprising:
a user input
a processor; and
a memory
wherein the processor is adapted to update a dialogue state in response to a natural language input from a user, the dialogue state being stored in the memory,
the dialogue state comprising data structure that the stores the information exchanged between the user and the dialogue system,
the processor being configured to update said dialogue state by comparing said natural language input from the user with a plurality of possible actions, said actions indicating possible requests of the user, and update the state using information from an action that matches with the natural language input, the processor being configured to generate a response to the natural language input using the updated state.

In a further embodiment, a computer implemented method is provided for updating a dialogue state for use in a dialogue system, the dialogue system for conducting a dialogue with a user, the method comprising:
receiving a natural language input from a user;
using a processor to update a dialogue state in response to a natural language input from a user, the dialogue state being stored in the memory, the dialogue state comprising a data structure that the stores the information exchanged between the user and the dialogue system, and
update said dialogue state by comparing said natural language input from the user with a plurality of possible actions, said actions indicating possible requests of the user, and update the state using information from an action that matches with the natural language input.

In a further embodiment, a method for training a classifier for updating a state in a dialogue system, the method comprising:
providing a classifier, said classifier being capable of comparing a natural language input from the user with a possible action such that the classifier outputs a score indicating a match when the natural language input matches the possible action;
training said classifier using a data set comprising natural language inputs and possible actions, said data set comprising positive combinations where a natural language input and possible action are a match and distractors where the natural language input and possible action do not match.

In the above method, the possible actions are selected from candidate actions and state update actions wherein candidate actions indicate a question asked by the user of a previous response from the system and state update actions indicate a request from the user not linked to a previous response from the system.

The training of the classifier may be performed jointly with the training of the policy model or separately.

The above methods may be performed using a computer-readable medium comprising instructions which, when executed by a computer, cause the computer to carry out the above method.

A user input in a dialogue system can be understood using a combination of Natural Language Understanding (NLU) and Dialogue State Tracking (DST) components. NLU identifies domain-specific intents and entities in a user input and DST updates the dialogue state.

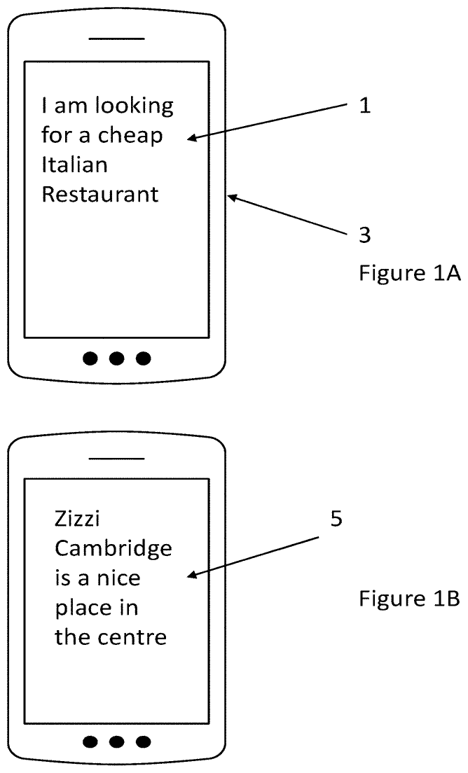

FIGS. 1A and 1B are schematics of a smart phone to illustrate the use of a method in accordance with an embodiment. In FIG. 1A, a user inputs a question 1 “I am looking for a cheap Italian Restaurant” into phone 3. In FIG. 1B, the phone 5 responds with “Zizzi Cambridge is a nice place in the centre”.

FIGS. 1A and 1B show one example of a task oriented dialogue system which relates to a restaurant search in Cambridge which will be used in this description. However, the method can be applied to any task-oriented dialogue system such as information search, customer support, e-commerce, physical environment control, and human-robot interaction which receive a natural language input from the user. The user input can be received via a microphone as speech which is then processed via speech recognition or it can be a text input.

Although a smart phone is shown, the method can be implemented on any device with a processor. For example, a standard computer, any voice-controlled automation, a server configured to handle user queries at a shop, bank, transport provider et cetera.

A conversation is shown below:

| Turn | User: | Iam looking for a cheap Italian restaurant. |
|---|---|---|
| 1 | | |
| Turn | System: | Zizzi Cambridge is a nice place in the center. |
| 2 | | |
| Turn | User: | How about Indian? |
| 3 | | |
| Turn | System: | Nando is a cheap Indian place you might like. |
| 4 | | |
| Turn | User: | What is the address of the Italian place? |
| 5 | | |
| Turn | System: | The address of Zizzi Cambridge is . . . |
| 6 | | |

The user inputs a query in Turns 1, 3, and 5 and the system responds in turns 2, 4 and 6 respectively.

In the fifth turn of the above dialogue, the user asks for the address of a restaurant presented by the system three turns earlier (Zizzi) and following a presentation of another restaurant (Nando). The user identifies the target restaurant with the referring expression ‘the Italian place’. This type of dialogue is particularly problematic for dialogue systems.

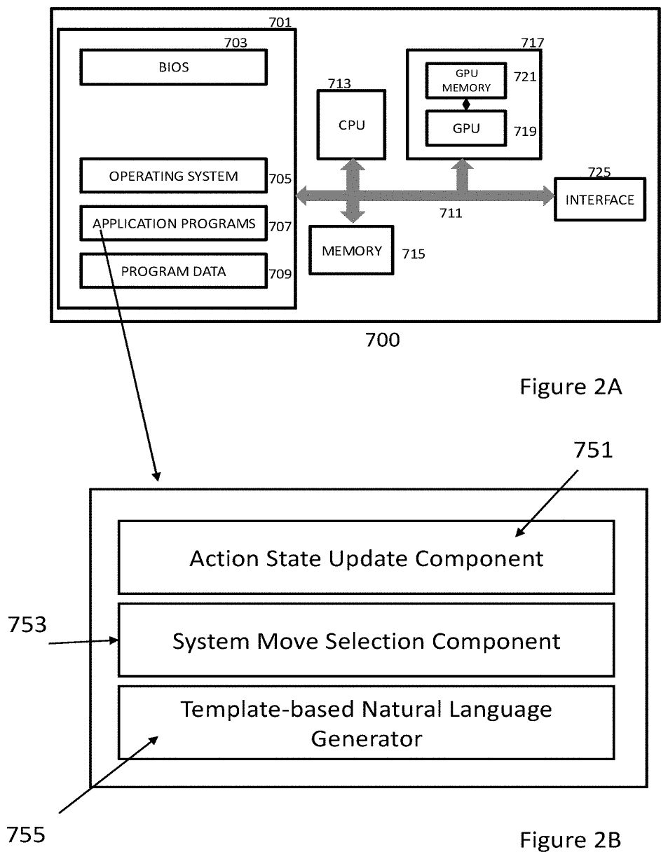

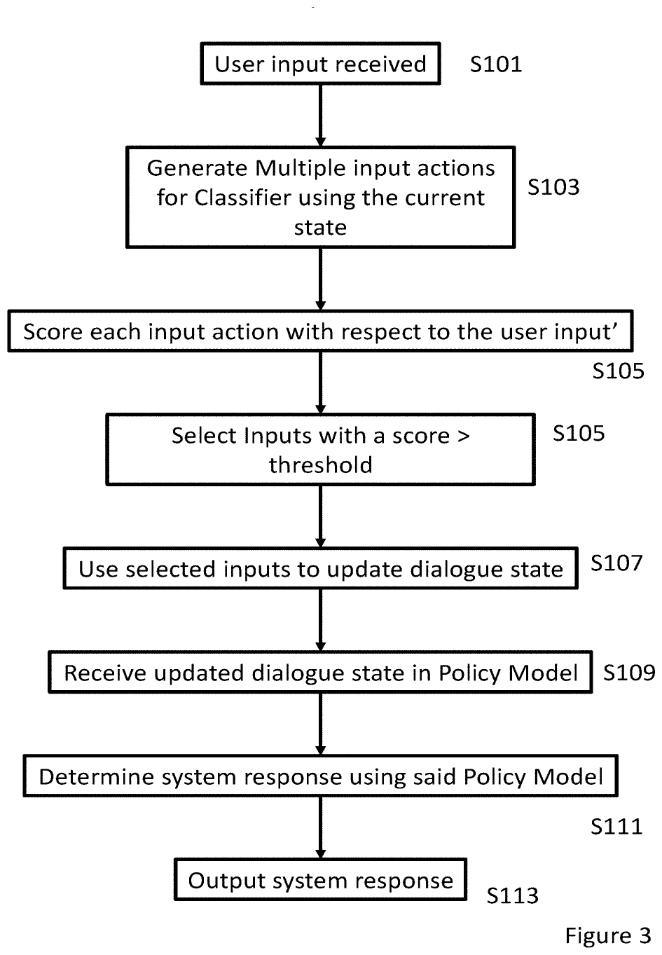

The dialogue that shown above is achieved using the system that will be described with reference to FIGS. 2A and 2B and also the flow chart of FIG. 3.

FIG. 2A is a schematic of the hardware that can be used to implement methods in accordance with embodiments. It should be noted that this is just one example and other arrangements can be used.

The hardware comprises a computing section 700. In this particular example, the components of this section will be described together. However, it will be appreciated they are not necessarily co-located.

Components of the computing system 700 may include, but not limited to, a processing unit 713 (such as central processing unit, CPU), a system memory 701, a system bus 711 that couples various system components including the system memory 701 to the processing unit 713. The system bus 711 may be any of several types of bus structure including a memory bus or memory controller, a peripheral bus and a local bus using any of a variety of bus architecture etc. The computing section 700 also includes external memory 715 connected to the bus 711.

The system memory 701 includes computer storage media in the form of volatile/or non-volatile memory such as read-only memory. A basic input output system (BIOS) 703 containing the routines that help transfer information between the elements within the computer, such as during start-up is typically stored in system memory 701. In addition, the system memory contains the operating system 705, application programs 707 and program data 709 that are in use by the CPU 713.

Also, interface 725 is connected to the bus 711. The interface may be a network interface for the computer system to receive information from further devices. The interface may also be a user interface that allows a user to respond to certain commands et cetera.

In this example, a video interface 717 is provided. The video interface 717 comprises a graphics processing unit 719 which is connected to a graphics processing memory 721.

Graphics processing unit (GPU) 719 is particularly well suited to the training of the classifier due to its adaptation to data parallel operations, such as neural network training. Therefore, in an embodiment, the processing for training the classifier may be divided between CPU 713 and GPU 719.

It should be noted that in some embodiments different hardware may be used for the training the classifier and for performing the state update. For example, the training of the classifier may occur on one or more local desktop or workstation computers or on devices of a cloud computing system, which may include one or more discrete desktop or workstation GPUs, one or more discrete desktop or workstation CPUs, e.g. processors having a PC-oriented architecture, and a substantial amount of volatile system memory, e.g. 16 GB or more. While, for example, the performance of the dialogue may use mobile or embedded hardware, which may include a mobile GPU as part of a system on a chip (SoC) or no GPU; one or more mobile or embedded CPUs, e.g. processors having a mobile-oriented architecture, or a microcontroller-oriented architecture, and a lesser amount of volatile memory, e.g. less than 1 GB. For example, the hardware performing the dialogue may be a voice assistant system 120, such as a smart speaker, or a mobile phone including a virtual assistant.

The hardware used for training the classifier may have significantly more computational power, e.g. be able to perform more operations per second and have more memory, than the hardware used for performing tasks using the agent. Using hardware having lesser resources is possible because performing speech recognition, e.g. by performing inference using one or more neural networks, is substantially less computationally resource intensive than training the speech recognition system, e.g. by training one or more neural networks. Furthermore, techniques can be employed to reduce the computational resources used for performing speech recognition, e.g. for performing inference using one or more neural networks. Examples of such techniques include model distillation and, for neural networks, neural network compression techniques, such as pruning and quantization.

For conducting dialogue, the application programs 707 of FIG. 2A have three main modules which are shown in FIG. 2B. These are: 1) an action state update component 751, 2) a system move selection component 753, and 3) a template-based natural language generator 755.

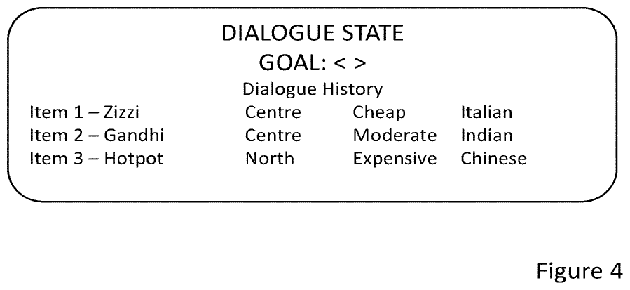

The dialogue system operates using a dialogue state. An example of a dialogue state is shown in FIG. 4. In an embodiment, a dialogue state stores the system beliefs about the user goal and dialogue history, including previously discussed items. After each utterance or user input, the state is updated by the action state update component 751. The updated state is then passed to the system move selection component 753. This system move selection component 753 receives the updated state and applies a system move selection policy to determine an answer. There are many possible options for the system move selection component or “policy component” as there are many such modules that are configured to provide a response upon the receipt of an updated state. In an embodiment, a statistically learned policy is used.

However, other systems that use rule-based approaches could also be used. In an example, the following method could be used. Jost Schatzmann et al., “Agenda-based user simulation for bootstrapping a POMDP dialogue system,” in Human Language Technologies 2007. Apr. 2007, pp. 149-152, Association for Computational Linguistics.

The output of the a system move selection component 753 is then converted to a natural language response by template based natural language generator 755.

FIG. 4 shows an example of a state. The state comprises a Goal. In this particular example, the goal is represented by the 3 slots: food, area, price range. At the beginning of the dialogue, each slot is empty, but the slots are populated as more information is gathered from the user.

The dialogue state also comprises dialogue history. In this example, the dialogue history contains 3 items, but it should be noted that the number of items is not fixed and will increase as more items are added during the dialogue. The system of this embodiment defines the history in terms of a slot-filling systems, which, in this example, allows a user to find a restaurant matching specified area, price range, or food type. These are the informable slots in the domain definition of this example and are set out in the dialogue history for each item (which in this case is a restaurant). In addition to the informable slots, requestable slots are also defined. In this example, the requestable slots are phone number, address, post code, area, price range, and food type. The slots are defined by the domain.

In an embodiment, a state update is seen as a set of operations, or actions. Each action changes a value in the dialogue state. For example, a state update action for the utterance ‘I am interested in Italian food’ updates the user goal with food=Italian. A state update action for the utterance ‘What area is the Italian restaurant in?’ switches on a request bit for the area field of the entity matching the property food=Italian. Action detection is the task of identifying which state modifying actions are intended by the user in a given context. In our approach, actions, which are instructions for the state modification, are detected without a semantic parse of the utterance.

The entire process will be explained with reference to the flow chart of FIG. 3. In step S101, a user input is received this is a natural language input.

In step S103, a multiple input actions are generated these can be a candidate request action and a goal changing action. A candidate request action is generated for each of the requestable slots for each item stored in the dialogue history. For example, if the dialogue history contains three restaurants, 18 request candidate actions are generated (6 requestable slots×3 items). Changing the user goal, in contrast, is a context-independent action. Given the domain ontology, the model classifies the same number of the goal changing actions in each turn, corresponding to the (informable) slot-value pairs. For example, the Cambridge restaurants domain has 102 values for the food type, area, and price range slots.

These are then converted as an input to a model. In this embodiment, the input to the model is a word sequence, consisting of: 1) a word sequence derived from the last utterance of the system, this might be the system utterance as it appear or in the form of a lexicalized dialogue acts, 2) the user utterance from step S101, 3) the item description, and 4) a template-generated action sentence. An item description is a string generated from the action. For item-independent actions (goal changes), the item description is empty; for item-dependent actions (information requests), it corresponds to the description of the requested item. The description corresponding to the action request address of the first item for the state in FIG. 4 is ‘NAME zizi AREA center PRICE cheap FOOD italian’.

To illustrate this, for this example the system generates 18 inputs for request actions:

Nando is a nice restaurant in the North SEP What is the price range of the Italian restaurant? SEP NAME zizi AREA center PRICE cheap FOOD Italian SEP What is the phone number?

Nando is a nice restaurant in the North SEP What is the price range of the Italian restaurant? SEP NAME zizi AREA center PRICE cheap FOOD Italian SEP What is the address?

Nando is a nice restaurant in the North SEP What is the price range of the Italian restaurant? SEP NAME zizi AREA center PRICE cheap FOOD Italian SEP What is the post code?

Nando is a nice restaurant in the North SEP What is the price range of the Italian restaurant? SEP NAME zizi AREA center PRICE cheap FOOD Italian SEP What is the area?

Nando is a nice restaurant in the North SEP What is the price range of the Italian restaurant? SEP NAME zizi AREA center PRICE cheap FOOD Italian SEP What is the price range?

Nando is a nice restaurant in the North SEP What is the price range of the Italian restaurant? SEP NAME zizi AREA center PRICE cheap FOOD Italian SEP What is the food type?

Nando is a nice restaurant in the North SEP What is the price range of the Italian restaurant? SEP NAME Gandhi AREA Centre PRICE moderate FOOD Indian SEP What is the phone number?

Nando is a nice restaurant in the North SEP What is the price range of the Italian restaurant? SEP NAME Gandhi AREA Centre PRICE moderate FOOD Indian Italian SEP What is the address?

Nando is a nice restaurant in the North SEP What is the price range of the Italian restaurant? SEP NAME Gandhi AREA Centre PRICE moderate FOOD Indian SEP What is the post code?

Nando is a nice restaurant in the North SEP What is the price range of the Italian restaurant? SEP NAME Gandhi AREA Centre PRICE moderate FOOD Indian SEP What is the area?

Nando is a nice restaurant in the North SEP What is the price range of the Italian restaurant? SEP NAME Gandhi AREA Centre PRICE moderate FOOD Indian SEP What is the price range?

Nando is a nice restaurant in the North SEP What is the price range of the Italian restaurant? SEP NAME Gandhi AREA Centre PRICE moderate FOOD Indian SEP What is the food type?

Nando is a nice restaurant in the North SEP What is the price range of the Italian restaurant? SEP NAME Hotpot AREA North PRICE expensive FOOD Chinese SEP What is the phone number?

Nando is a nice restaurant in the North SEP What is the price range of the Italian restaurant? SEP NAME Hotpot AREA North PRICE expensive FOOD Chinese SEP What is the address?

Nando is a nice restaurant in the North SEP What is the price range of the Italian restaurant? SEP NAME Hotpot AREA North PRICE expensive FOOD Chinese SEP What is the post code?

Nando is a nice restaurant in the North SEP What is the price range of the Italian restaurant? SEP NAME Hotpot AREA North PRICE expensive FOOD Chinese SEP What is the area?

Nando is a nice restaurant in the North SEP What is the price range of the Italian restaurant? SEP NAME Hotpot AREA North PRICE expensive FOOD Chinese SEP What is the price range?

Nando is a nice restaurant in the North SEP What is the price range of the Italian restaurant? SEP NAME Hotpot AREA North PRICE expensive FOOD Chinese SEP What is the food type?

And the 102 inputs for goal change actions are of the type:

Nando is a nice restaurant in the North SEP What is the price range of the Italian restaurant? SEP SEP food Italian

Nando is a nice restaurant in the North SEP What is the price range of the Italian restaurant? SEP SEP food Chinese

Nando is a nice restaurant in the North SEP What is the price range of the Italian restaurant? SEP SEP area center

In the above, SEP indicates separation between sentences.

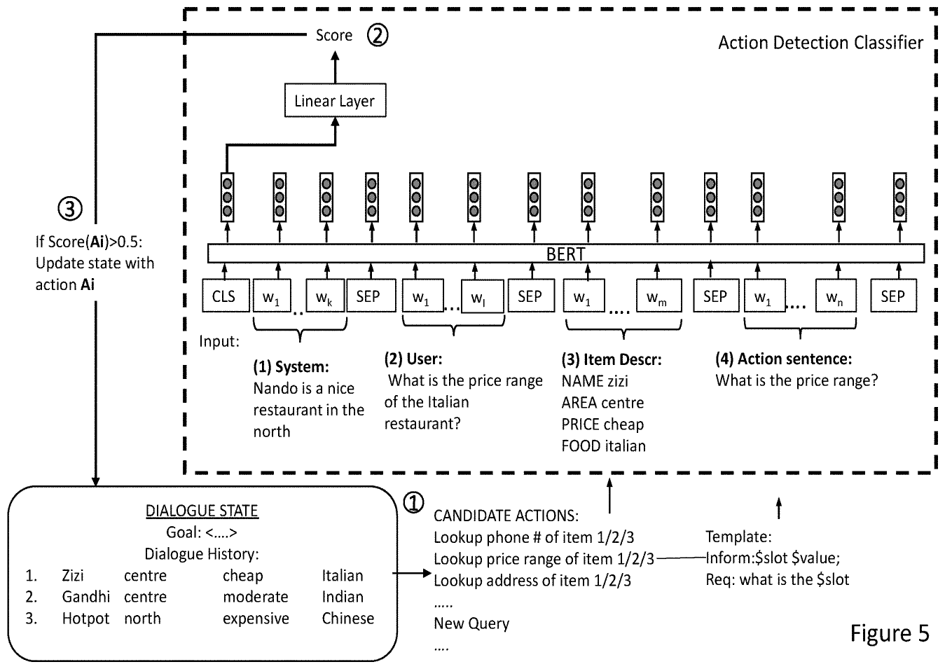

In step S105, the inputs are scored. In an embodiment, this is done by passing the inputs into a trained model which is a bidirectional transformer. This is shown schematically in FIG. 5. The input comprising: 1) System, 2) User, 3) Item description and 4) action sentence is shown being input as a sequence in to bidirectional encoder (which in this case is BERT). A classification flag CLS is generated for the whole input and this is then fed through linear layer to produce a score. By including an item description in the model input, the attention mechanism of the transformer model learns to detect whether an action can be inferred from a user utterance in a given context. The presence of the item description, the dynamic generation of candidate actions, and the method of data generation allow the model to interpret referring expressions.

The above method where the input is comprised on different parts has the potential advantage is that it encodes semantics from pre-training.

In the above an “action sentence” e.g. “What is the price range” as an input as opposed to just using the words “Price range”. However, just the words “Price range” could also be used. A sentence was created because ‘request price range’ is not natural and BERT is optimised to operate on natural language.

In step S107, the inputs are selected with a score greater than a threshold which in this case is 0.5. These inputs are then used to update the state in step S109, i.e., to update the dialogue state by either changing the goal (a slot value) or setting a request bit on one of the items in the dialogue history. During the update, the following heuristics are applied: 1) if multiple actions for a slot are predicted, the one with the highest score is used; 2) if multiple request actions receive score >0.5, the request bit for the most recently mentioned item only is used. As explained above, the dialogue state stores the dialogue history in the order of the most recently mentioned and therefore, it is possible to easily determine the most recently mentioned item. Once a request bit is set, this information is passed to the policy module which will then make a decision on how to handle the information that a request bit is set in light of other state update information, for example, the goal being updated. In an embodiment, the policy model is a classifier that chooses the template for the system response. It could also be a rule-based response selection where a rule is triggered by setting of a request bit.

In step S111 the updated dialogue state is then received by the policy model which is used to provide a system response in step S113. A natural language response can be generated using a Natural language generation component to provide the output in S113. The system response is then provided to the user and the user response is awaited. Once the user input is received, the process is back to step S101 and starts again. However, here the system response in step S113 is used to generate the multiple inputs.

In the embodiments described above a set of candidate actions from the dialogue state are generated. Context is stored in the dialogue state and a statistical method is used to update the dialogue state. A binary classification is used to detect actions intended by the user. These action then deterministically update the state.

The proposed ‘action detector’ model is trained to identify actions intended by the user utterance from a list of candidate actions. Candidate actions in a task-oriented dialogue system are dynamically generated based on the current dialogue state and the domain ontology. The above embodiment takes as the input words of the user's utterance, such as the text typed in text-based chat, or the output of a speech recognizer in a spoken dialogue system.

In the above embodiment, a state update is seen as a set of operations, or actions. Each action changes a value in the dialogue state, which stores the system beliefs about the user goal and dialogue history, including previously discussed items. For example, a state update action for the utterance ‘I am interested in Italian food’ updates the user goal with food=Italian. A state update action for the utterance ‘What area is the Italian restaurant in?’ switches on a request bit for the area field of the entity matching the property food=Italian.

FIG. 5 shows a schematic of the process and model which can be understood from the above description of FIG. 3. In FIG. 5 $slot is one of price range, area, food type and $value is their values stored in the database (cheap/moderate/expensive, north/south/ . . . , indian/italian/ . . . )

In an embodiment, the above state update module performs the following three basic steps:

1) infer the candidate actions from the dialogue state

2) compute relevance score for each candidate action

3) update the state with the most likely actions

The first step of the algorithm, generating a set of candidate actions for the current dialogue state, is deterministic. Actions can be inferred from the current state. The last step of updating of the state given the set of actions is also deterministic. The second step of the algorithm is to score each candidate action with the probability of it being intended by the user.

In the above embodiment, a BERT encoder and a linear layer with a binary output is used. The input to the model is a word sequence, consisting of: 1) a sequence of lexicalized dialogue acts, 2) a user utterance, 3) an item description, and 4) a template-generated action sentence. An item description is a string generated from the action. For item-independent actions (goal changes), the item description is empty; for item-dependent actions (information requests), it corresponds to the description of the requested item. The model outputs a probability whether an action was intended by the user.

Next the training of the classifier will be described. The classifier is trained using with positive and negative examples:
<sys, usr, action→(itemdescr, actionsent)>: 0/1

The term “sys” is the previous system response, “usr” the user utterance and action is the intended action by the user. To match with the above described example, “action” is subdivided into item description and action sentence as described above.

To create the training set, in the positive examples (labeled 1), the action is intended by the user and in the negative examples (labeled 0), it is not. Since action is an instruction on the current state, e.g. ‘request price range of the first item’, the item description and action sentence inputs to the model are inferred from the action and the state. Three datasets for training the classifier are summarized below in Table 2.

TABLE 2

| | | train/dev data size |
|---|---|---|
| Model | Generation method | (% positive) |
| init | from DSTC2 | 72/24 K (15%) |
| +extH | expand w. heuristics | 137/43 K (12%) |
| +extA | expand w. active learning | 101/31 K (16%) |

The baseline dataset is generated from the training split of the DSTC2 corpus. For each turn, a positive example is generated for each action intended by the user. The intended actions are inferred from the manual NL annotation, for example, Action is extracted from the NL annotation, e.g. ‘I want italian/FOOD_TYPE food’/REQUEST_FOOD corresponds to action request_italian. To generate the negative examples (distractors), it was considered to use all valid unintended actions (slot-value pairs). However, this created a highly skewed dataset when the number of actions is large. Instead, for each positive example, the unintended actions were sampled using frequency and similarity heuristics to select more relevant distractors. By the design of the task, the DSTC2 dataset does not contain referring expressions in user turns. All user requests are generic and refer to the last presented item (e.g., What is the phone number?). Hence, a model trained on the baseline dataset can only understand references to the last presented item.

The extH extends the baseline dataset with the automatically generated utterances with referring expressions. A user may ask a question about any of the requestable slots and refer to any of the informable slots. To do this, 10K/3K requests were generated with referring expressions for training/development dataset for all combinations of requestable and informable slots by randomly sampling a request utterance without a referring expression for the request slot from DSTC2 dataset and concatenating it with a template-generated referring expression for the reference slots (see Table 3).

TABLE 3
Generated requests with referring expressions for
sampled item (zizzi, cheap, italian, center).

| Req. | Ref. | Generic | | |
|---|---|---|---|---|
| slot | slot | request | Template | Simulated user request |
| food | name | — | What type of food does | What type of food does |
| | | | $name serve? | zizzi serve? |
| price | area | price range | for the restaurant in the | price range for the place in |
| | | | $area | the center |
| area | price | area | of the $price place | area of the cheap place |
| area | food | what's the | for the $food place | what's the area for the |
| | | area | | italian place |

As shown in table 2, a further data set is generated using active learning. The key idea of is to allow an algorithm to select the training examples. The extA dataset of table 2 is generated by automatically selecting the most challenging distractors from simulated dialogues.

The training set can be extended to explore multiple venues by repeatedly changing the goal constraints and then request slots for venues that were offered earlier in the dialogue. In addition, templates were created for generating utterances with referring expressions for this new behaviour, resulting in a hybrid retrieval/template based model for generating simulated user utterances.

As a test, first the simulation was run with the ASU module using the classifier trained on the baseline dataset for 5000 dialogues. In the simulation instead of a real user, another system is used to simulate a user. In this particular example, a rule-based simulated user was employed that receives a randomly selected goal and generates utterances to resemble a human-computer dialogue. From the simulated user intents, the ‘intended’ user actions were inferred and the new training examples were automatically label. Each ‘intended’ action for which the baseline model predicted a relevance score <T1 is used as a positive example. The top M ‘unintended’ actions with the highest relevance score >T2 are used as a negative example. In this test T1=0.99, T2=0.5, and M=2. All generated utterances with referring expressions are also used as positive examples, even if they were correctly classified with the model trained on the baseline dataset.

To demonstrate the above, the ASU approach was trained with the baseline model on the test subset of the DSTC2 corpus, i.e., without referring expressions. Using the manual transcript of the user input, the model correctly identified 96% of user informs and 99% of user requests (average goal and request accuracy as computed by the official DSTC2 evaluation script).

Next, the proposed approach was evaluated on simulated dialogues with referring expressions in user requests. The simulation was run with the proposed action state update component trained on the baseline, expH, and expA datasets. The results are shown in table 4.

TABLE 4
Evaluation with a user simulator. The top experimental scores are highlighted

| | | | | | | | Accuracy | |
|---|---|---|---|---|---|---|---|---|
| | State Update | | | | Turn: | State | with | request |
| ASU | method for | | Dialogue: | | with | Update | user # | act |
| train | Policy | average | success | all | user | act | per | accuracy |
| set | training | length | rate | accuracy | inform | accuracy | dialog | (std) |
| baseline | DA | 10.06 | 43.9% | 50.0% | 4.6 | 58.6% | 3.3 | 30.9% |
| expH | DA | 9.17 | 91.1% | 75.1% | 3.9 | 79.0% | 2.4 | 50.0% |
| expH | ASU w. expH | 9.97 | 92.0% | 74.7% | 4.1 | 75.9% | 2.2 | 54.3% |
| expA | DA | 8.15 | 99.5% | 98.1% | 3.7 | 98.8% | 1.5 | 94.0% |
| expA | ASU w. expA | 8.02 | 99.4% | 98.3% | 3.7 | 98.6% | 1.5 | 95.4% |
| GOLD | DA | 7.93 | 99.8% | 100% | 3.7 | 100% | 1.2 | 100% |

As an upper bound (GOLD) condition, the simulation was run with the correct actions inferred from the simulated dialogue acts. The policy model is trained with the agenda-based simulation using dialogue acts (DA) as input and 25% dialogue act confusion rate. For the models trained on expH and expA, a policy model was also trained with simulated user utterances, rather than dialogue act hypotheses, as input. In this condition, the policy may learn to overcome state update errors made by the ASU model.

5000 dialogues were simulated for each experimental condition and the statistics were computed for the dialogues and individual turns. The dialogue success rate is the proportion of the simulated dialogues where the system offered a venue matching the simulated user's goal constraints (possibly after a number of goal changes), and provided the additional information requested by the simulated user. The state update accuracy is computed as the average accuracy across: a) all turns, b) turns annotated as inform only, and c) turns annotated as request only.

The simulated user behaviour is affected by the state update model. The average length of a simulated dialogue ranges between 7.93 for the GOLD condition and 10.06 for the baseline. The lower state update accuracy leads to longer dialogues because when the system fails to respond correctly, the simulated user repeats or rephrases the request increasing the dialogue length. The baseline condition achieves only 43.9% dialogue success and 50.0% state update accuracy on all user turns. In the expH DA condition, the dialogue success and the overall accuracy increase to 91.1% and 75.1% with an accuracy of 79.0% on informs but only 50.0% on requests. With the active learning approach (expA DA), the dialogue success and the overall accuracy increase to 99.5% and 98.1% with an accuracy of 98.8% on informs and 94.0% on requests. Using a matched policy affects the performance for both expH and expA models, increasing the accuracy on requests by 4.3 and 1.4 absolute % points. However, using the policy trained with the expH model decreases the accuracy on user inform acts by 3.1% points and increases the dialogue length. The results show that the action state update approach is effective in combination with active learning.

In order to test the proposed action detection model with real users, a preliminary user study was carried out. The text-based system consists of the proposed dialogue state tracker using the expA action detection model, a dialogue policy trained with the text-based user simulator, and a template-based natural language generator. Subjects were recruited and asked to carry out five tasks involving restaurant information navigation. In each task, a subject was given an initial set of constraints (e.g., food type: Chinese, price range: cheap) and asked to get a suitable recommendation from the system. They then continue their conversation to get two alternative recommendations by changing the constraints, obtaining three recommended venues in total. Finally, they were asked to get additional information such as the phone number or the address for two of these venues. Subjects were also asked to indicate when they felt a system response was incorrect, by entering <error>. After completing all 5 tasks, they filled out a questionnaire, consisting of 5 statements to score on a 6 point Likert scale, ranging from ‘strongly disagree’ to ‘strongly agree’, and a question asking how many tasks were successfully completed (see Table 5).

TABLE 5
Human Evaluation Results
Average # turns (std. dev) per user60.9 (16.0)
Average % turns (std. dev) marked as error15% (10.0%)

| | |
|---|---|
| The system understood me well | 4.4 |
| The systems' responses were appropriate | 4.3 |
| I was able to retrieve the information about | 4.6 |
| the venues | |
| The system understood my references to | 4.8 |
| the venues | |
| I would recommend this system to my | 3.9 |
| friend | |
| How many of the 5 tasks were you able to | 3.6 |
| complete? | |

Each user entered 60.9 turns on average and marked 15% of them as errors. The questionnaire results indicate that the system understood their references to the venues (average score 4.8). Half of the users indicated that they completed all five tasks and only one of the users felt that the system did not understand them well. High standard deviation across users indicates high variability in user experience and possibly expectation of the system. The human evaluation shows that the above model can be used in an interactive dialogue system.

The embodiments described herein provide a novel approach for updating the dialogue state and that can successfully interpret user utterances, including the requests with the referring expressions. The experimental models were trained by extending the initial Cambridge restaurants dataset with the simulated requests containing referring expressions and sampled distractors. The model trained on the dataset where the distractors were sampled using the active learning approach, achieved the best performance despite the smaller size of its training sets. The human evaluation of this model showed that the approach can be used in an dialogue system with real users.

Whilst certain embodiments have been described, these embodiments have been presented by way of example only, and are not intended to limit the scope of the inventions. Indeed, the novel devices, and methods described herein may be embodied in a variety of other forms; furthermore, various omissions, substitutions and changes in the form of the devices, methods and products described herein may be made without departing from the spirit of the inventions. The accompanying claims and their equivalents are intended to cover such forms or modifications as would fall within the scope and spirit of the inventions.

1. A module for updating a dialogue state for use in a dialogue system, the dialogue system for conducting a dialogue with a user, the module comprising:
a user input
a processor; and
a memory
wherein the processor is adapted to update a dialogue state in response to a natural language input from a user, the dialogue state being stored in the memory,
the dialogue state comprising a data structure that the stores the information exchanged between the user and the dialogue system, and
the processor being configured to update said dialogue state by comparing said natural language input from the user with a plurality of possible actions, said actions indicating possible requests of the user, and update the state using information from an action that matches with the natural language input.

2. A module according to claim 1, wherein the dialogue state comprises a data structure that comprises items that have been mentioned during the dialogue.

3. A module according to claim 2, wherein said plurality of possible actions includes actions regarding a plurality of items that have been mentioned during the dialogue.

4. A module according to claim 1, wherein the dialogue system is configured for information retrieval and said dialogue state comprises a user goal and history, said user goal indicating information that the user requires, said history defining items that have been previously retrieved in response to a user goal.

5. A module according to claim 1, wherein the processor is configured to compare the natural language input from the user with a plurality of possible actions, by using a binary classifier to indicate actions that are a match and those which are not.

6. A module according to claim 5, wherein the binary classifier is configured to output a score and said score is compare with a threshold to determine if an action is a match.

7. A module according to claim 6, wherein the processor is configured to compare the natural language input from the user with a plurality of possible actions, by generating a plurality of model inputs for each action, each model input comprising the natural language input from the user and an action, the processing being further configured to input the model input to a binary classifier implemented as a trained machine learning model to output said score.

8. A module according to claim 7, wherein the trained machine learning model is a transformer based trained machine learning model.

9. A module according to claim 7, wherein the trained machine learning model is a bi-directional trained machine learning model.

10. A module according to claim 7, wherein the model inputs further comprise a previous response from the dialogue system.

11. A module according to claim 7, wherein the actions are selected from candidate actions and state update actions wherein candidate actions indicate a question asked by the user of a previous response from the system and state update actions indicate a request from the user not linked to a previous response from the system.

12. A module according to claim 11, wherein module inputs for candidate actions comprise: a representation of the previous response of the system; the user input; an item description of the items in the dialogue state history; and a proposed question relating to the item referred to in the item description.

13. A module according to claim 11, wherein module inputs for state update actions comprise: a representation of the previous response of the system; the user input; and a proposed question relating to a possible user query.

14. A module according to claim 12, configured to set a request bit when a module input for a candidate action is matched.

15. A module according to claim 13, configured to update the state when a module input for a state update action is matched.

16. A method for training a classifier for updating a state in a dialogue system, the method comprising:
providing a classifier, said classifier being capable of comparing a natural language input from the user with a possible action such that the classifier outputs a score indicating a match when the natural language input matches the possible action;
training said classifier using a data set comprising natural language inputs and possible actions, said data set comprising positive combinations where a natural language input and possible action are a match and distractors where the natural language input and possible action do not match.

17. A method for training a classifier according to claim 16, wherein the possible actions are selected from candidate actions and state update actions wherein candidate actions indicate a question asked by the user of a previous response from the system and state update actions indicate a request from the user not linked to a previous response from the system.

18. A dialogue system comprising:
a user input
a processor; and
a memory
wherein the processor is adapted to update a dialogue state in response to a natural language input from a user, the dialogue state being stored in the memory,
the dialogue state comprising data structure that the stores the information exchanged between the user and the dialogue system,
the processor being configured to update said dialogue state by comparing said natural language input from the user with a plurality of possible actions, said actions indicating possible requests of the user, and update the state using information from an action that matches with the natural language input,
the processor being configured to generate a response to the natural language input using the updated state.

19. A computer implemented method for updating a dialogue state for use in a dialogue system, the dialogue system for conducting a dialogue with a user, the method comprising:
receiving a natural language input from a user;
using a processor to update a dialogue state in response to a natural language input from a user, the dialogue state being stored in the memory, the dialogue state comprising a data structure that the stores the information exchanged between the user and the dialogue system, and
update said dialogue state by comparing said natural language input from the user with a plurality of possible actions, said actions indicating possible requests of the user, and update the state using information from an action that matches with the natural language input.

20. A computer-readable medium comprising instructions which, when executed by a computer, cause the computer to carry out the method of claim 18.
